(19) United States
(12) Patent Application Publication
(10) Pub. No.: US 2022/0031114 A1
(43) Pub. Date: Feb. 3, 2022

(54) MULTISOURCE PRECISION LIQUID DISPENSER

(71) Applicants: Dana Datino, Valhalla, NY (US); Marie Tomanelli, Pleasantville, NY (US)

(72) Inventors: Dana Datino, Valhalla, NY (US); Marie Tomanelli, Pleasantville, NY (US)

(21) Appl. No.: 16/947,340

(22) Filed: Jul. 29, 2020

(51) Int. Cl. A47J 31/44; A47J 31/52

(52) U.S. Cl. CPC A47J 31/4485; A47J 31/007; A47J 31/5253; A47J 31/4496

(57) ABSTRACT

A liquid dispenser is provided. The liquid dispenser includes a housing; a temperature control system; and a pump system. The pump system pumps multiple liquids. A method of dispensing a liquid into a beverage is also provided. A liquid dispenser includes a valve, a pump, and a nozzle. A liquid is selected from multiple liquids and a beverage shade is selected. The valve and the pump are activated to deliver the selected liquid to the nozzle in an amount that achieves the selected beverage shade.

### BACKGROUND OF THE INVENTION

The present invention relates to a liquid dispenser and, more particularly, to a precision dispenser with multiple liquid sources.

Customers are often disappointed by inconsistent amounts of dairy product added to their beverage by different employees. In addition, coffee businesses lose product, time, and money due to the inconsistency of the amount of dairy product poured in a patron's coffee depending on location or employee.

There are currently no devices or systems that dispense a variety of dairy products and consistently pour the exact amount of dairy desired in each cup of coffee. U.S. Pat. No. 8,944,287 to Reyhanloo discloses a coffee machine with a device control electronic system which monitors milk level in the container. U.S. Pat. No. 9,357,873 to Reyhanloo teaches a coffee machine with a milk dispenser that chills the milk as well as monitors the fill level in the container. U.S. Pat. No. 10,568,455 to Buchholz et al. is drawn to a device for producing milk emulsions (froth) that pumps milk from a chilled container.

As can be seen, there is a need for an apparatus that can dispense a precise quantity of a selection of a variety of liquids.

The present invention provides an apparatus that consistently pours the exact amount of the customer's desired dairy product desired in each cup of coffee. The invention regulates the exact amount of dairy product deposited into each cup of coffee depending on cup size and type of dairy being used. According to the specific shade of coffee desired, our machine will dispense the exact amount of dairy product in each cup consistently. The machine may also dispense about five different types of dairy and/or nondairy milk to accommodate all customer needs.

The invention also provides a method that ensures the amount of dairy product poured achieves a specific shade of coffee. It will resolve inconsistency in coffee shade, while helping eliminate waste for businesses as well.

### SUMMARY OF THE INVENTION

In one aspect of the present invention, a liquid dispenser is provided, comprising a housing; a temperature control system; and a pump system; wherein the pump system is operable to pump a plurality of liquids.

In another aspect of the present invention, a method of dispensing a liquid into a beverage is provided, comprising providing a liquid dispenser comprising a pump and a nozzle; determining a liquid selection from a plurality of liquids; determining a shade selection of the beverage; determining a type of beverage to be shaded and a cup size containing said beverage; and activating the pump, thereby delivering the selected liquid to the nozzle in an amount effective to achieve the selected beverage shade, wherein the method is performed by a computing device.

In another aspect of the present invention, one or more non-transitory computer-readable media are provided, storing instructions which, when executed by one or more processors, cause performance of a method. The method comprises determining a liquid selection from a plurality of liquids; determining a shade selection of a beverage; determining a type of beverage to be shaded and a cup size containing said beverage; and activating a pump, thereby delivering the selected liquid to a nozzle in an amount effective to achieve the selected shade.

These and other features, aspects and advantages of the present invention will become better understood with reference to the following drawings, description and claims.

### BRIEF DESCRIPTION OF THE DRAWINGS

FIG. 1 is a perspective view of a dispenser according to an embodiment of the invention;

FIG. 2 is a perspective view thereof, shown in use;

FIG. 3 is a front elevation view of the interior thereof;

FIG. 4 is a front perspective view of the interior components thereof;

FIG. 5 is a side cross section view of interior components thereof;

FIG. 6 is a flow diagram of a method according to an embodiment of the present invention;

FIG. 7 is a schematic of a system according to an embodiment of the invention; and

FIG. 8 is a schematic illustrating a variety of results that may be produced according to a method according to an embodiment of the invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

As used herein, the term “dispenser” refers to the inventive machine in its entirety.

As used herein, the term “type of beverage” refers to a beverage selected from a variety of coffee and/or tea beverages. For example, the type of beverage may be espresso, brewed coffee, black tea, green tea, etc.

Broadly, one embodiment of the present invention is a dispenser that refrigerates a variety of liquids (e.g., dairy) and dispenses a precise amount of a selected liquid. The dispenser generally comprises a housing, a temperature control system, a pump system, and an electrical system.

The housing generally comprises a sub-frame with panels affixed thereto. The subframe provides rigid support for the affixed panels.

The materials of manufacture for each component of the inventive dispenser are not particularly limited. The subframe and the panels may be manufactured from any suitable material, such as extruded aluminum.

The temperature control system may comprise at least one compressor unit, at least one compressor relay unit, and at least one fan. The compressor unit may be a rigid heating, ventilation, and air conditioning (HVAC) unit.

The pump system may comprise at least one pump, preferably one pump for each liquid to be dispensed. For example, the dispenser may have about six pumps. The pumps may provide any suitable flowrate. For example, the pumps may provide a flowrate of about 240 L/h or higher. A plurality of solenoids may be provided, preferably one solenoid for each liquid to be dispensed. In some embodiments, the same number of solenoids are provided as pumps, e.g., about six.

The dispenser generally dispenses various liquids by means of one or more pumps and/or solenoids connected to a nozzle. Each pump may be connected to a dedicated food-grade tube that transfers the selected liquid from the solenoid to the nozzle. The nozzle may have from three to twelve holes, such as six holes, to keep the liquids from contaminating one another.

In some embodiments, the dispenser may dispense various liquids by means of a carbonated pressure system (i.e., carbon dioxide—CO₂) and solenoids.

The electrical system may comprise at least one computer with an input/output device, at least one relay module, and at least one data storage device with a program. The computer and input/output device may be, for example, a raspberry pi 3 model B+ with a raspberry pi 7 touch screen. The relay module may accommodate about 8 channels. The data storage device may be a secure digital (SD) card. The program may be, for example, code prepared using python script. The electrical components may operate on any suitable voltage, such as 12 VDC. The code enables the dispenser apparatus to deliver a predetermined amount of a predetermined liquid responsive to a user's selections.

In some embodiments, the apparatus may comprise one or more additional components selected from the group consisting of flow sensors, pH sensors, and liquid temperature sensors.

A method of using the apparatus may include the following. A barista or a customer may select the type of dairy liquid and the amount thereof from a point-of-sale (POS) system. The customer may select an amount of dairy liquid or a beverage shade, such as light, medium, or dark. The selection signals the designated pump causing the machine to automatically dispense the selected type of dairy liquid from its container in the specified amount through a dedicated pump, through a dedicated tube, and from a nozzle into the customer's coffee cup. After dairy is dispensed into the cup, the barista may give the coffee to the customer with confidence, knowing that it was made exactly to the customer's liking.

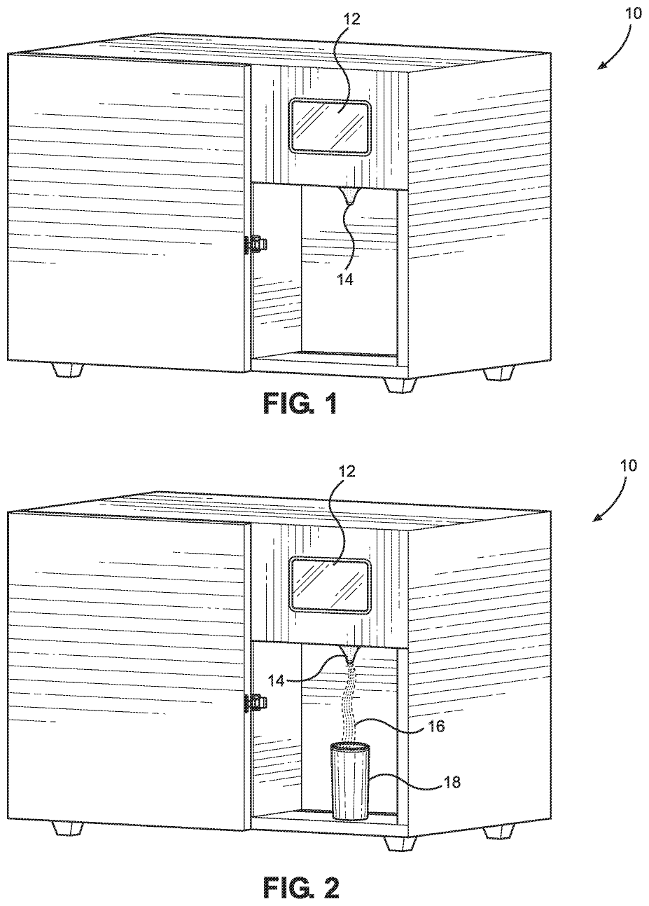

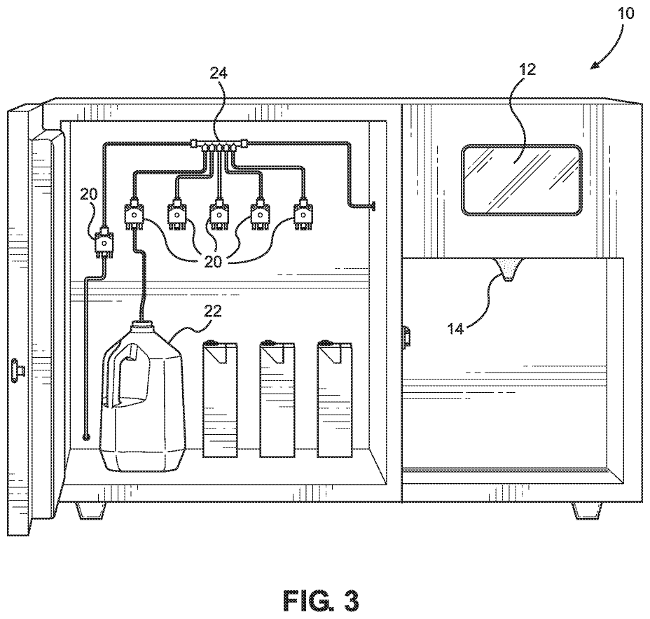

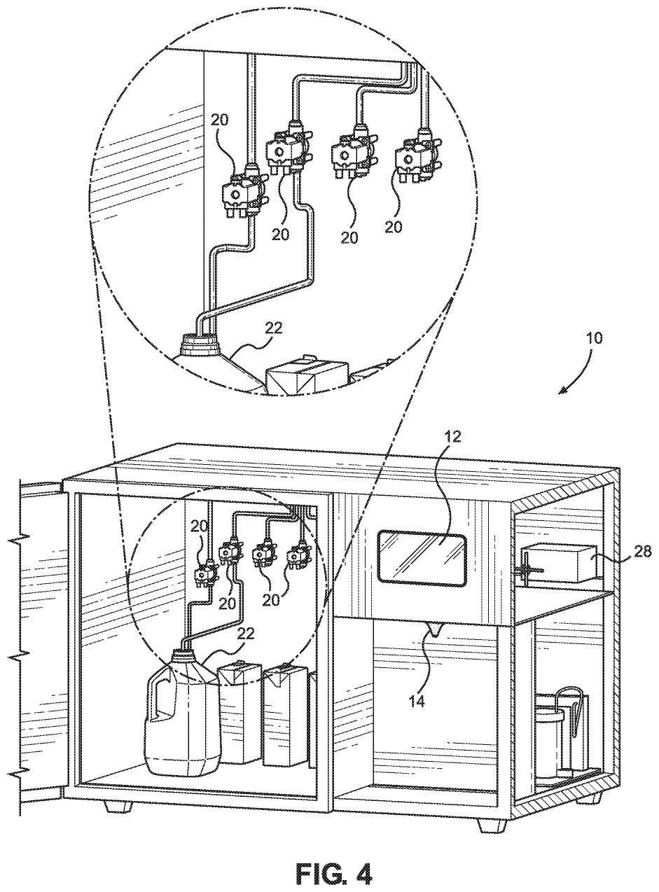

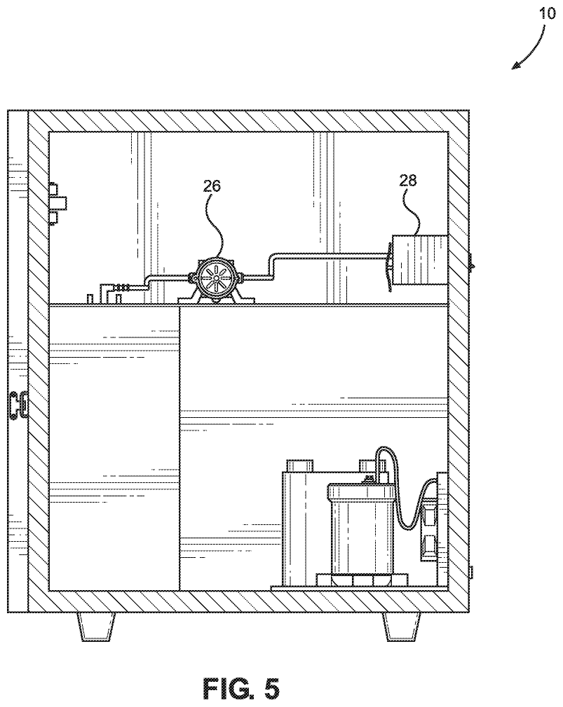

Referring to FIGS. 1-8, FIG. 1 shows the exterior of the dispenser 10, with a display 12 and a nozzle 14. FIG. 2 shows the dispenser 10 in use, with a liquid 16, dairy or nondairy, dispensing into a coffee cup 18. As shown in FIG. 3, solenoids 20, or solenoid valves, connected to a push-to-connect manifold 24 are arrayed above a dairy container 22 into which a tube is placed. The solenoids 20 serve as valves. FIGS. 4 and 5 show a peristaltic pump 26 and a power supply 28. When a solenoid 20 and the pump 26 are activated, liquid 16 may be pumped from the container 22 through the nozzle 14, as shown in FIG. 2. In other words, the solenoid valves 20 fluidly communicate with the nozzle 14 by way of the pump 26.

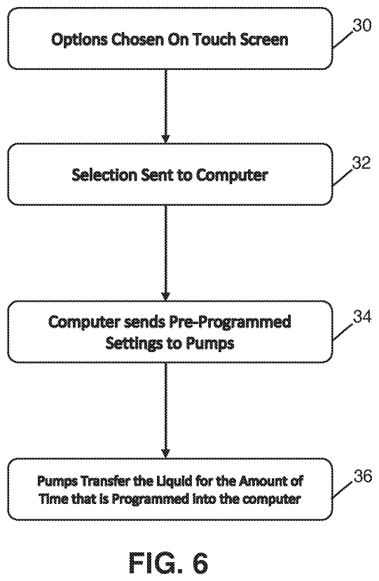

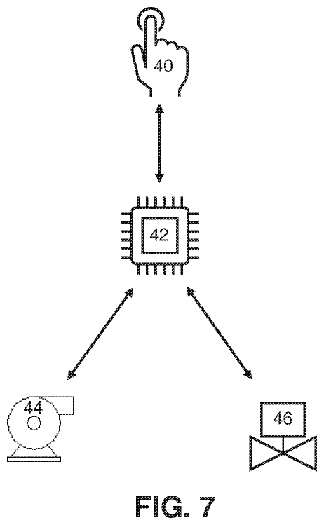

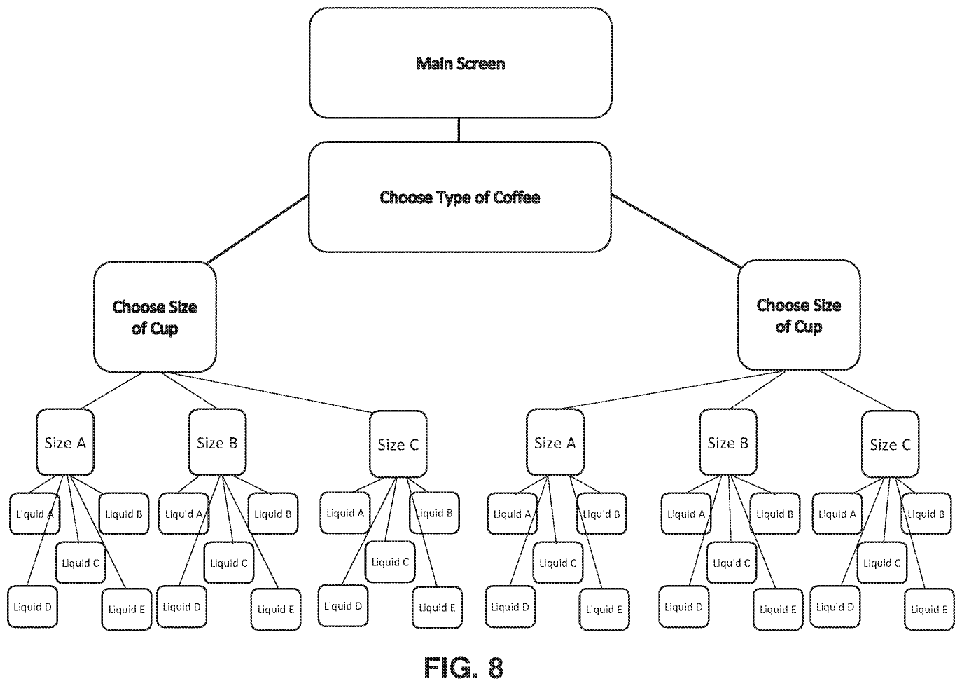

FIG. 6 illustrates a method of operation of a dispenser according to an embodiment of the invention, having a touch screen input device and multiple pumps. The user selects the desired options on the touch screen 30, which inputs the selection into the computer 32. The computer runs coding for preprogrammed responses to the selections made by the user 34. The preprogrammed responses activate a pump or pumps to transfer the selected liquid for a preprogrammed amount of time (e.g., seconds or fractions of a second) to achieve the amount of liquid corresponding to the user's selections 36. FIG. 7 shows a system according to an embodiment of the invention, wherein a touchscreen input device 40, a pump or pumps 44, and a plurality of valves 46 are provided. As shown in FIG. 7, the touchscreen device 40 transfers the user's selections to the computer 42 and displays output from the computer 42. The computer activates the pump or pumps 44 in coordination with the valves 46 to dispense the type and amount of liquid selected by the user. FIG. 8 is a simplified chart that illustrates the complexity of responses that are achievable utilizing the inventive system and apparatus. Since the dispenser is not limited to use with coffee and since many varieties of beverage may be used with the invention, the results from the preprogrammed system may be much more numerous.

It should be understood, of course, that the foregoing relates to exemplary embodiments of the invention and that modifications may be made without departing from the spirit and scope of the invention as set forth in the following claims.

What is claimed is:

1. A liquid dispenser, comprising:
a. a housing;
b. a temperature control system; and
c. a pump system;
wherein the pump system is operable to pump a plurality of liquids.

2. The liquid dispenser of claim 1, wherein the housing comprises a frame and a plurality of panels.

3. The liquid dispenser of claim 1, wherein the temperature control system comprises at least one compressor unit, at least one compressor relay unit, and at least one fan.

4. The liquid dispenser of claim 1, wherein the pump system comprises:
a. a plurality of solenoid valves;
b. at least one pump; and
c. a nozzle;
wherein the plurality of solenoid valves fluidly communicate with the nozzle by way of the at least one pump.

5. The liquid dispenser of claim 4, further comprising an electrical system comprising:
a. a computer with an input/output device;
b. at least one relay module; and
c. a data storage device;
wherein the electrical system is effective to activate one of the plurality of solenoid valves and the at least one pump to deliver a predetermined liquid in a predetermined amount.

6. The liquid dispenser of claim 4, further comprising an electrical system comprising:
a. a computer with an input/output device;
b. at least one relay module; and
c. a data storage device;
wherein the electrical system is effective to activate one of the plurality of solenoid valves and a carbonated pressure system to deliver a predetermined liquid in a predetermined amount.

7. The liquid dispenser of claim 1, wherein the pump system comprises:
a. a plurality of solenoid valves;
b. a carbonated pressure system; and
c. a nozzle;
wherein the plurality of solenoid valves fluidly communicate with the nozzle by way of the carbonated pressure system.

8. The liquid dispenser of claim 1, further comprising one or more components selected from the group consisting of flow sensors, pH sensors, and liquid temperature sensors.

9. A method of dispensing a liquid into a beverage, comprising:
a. providing a liquid dispenser comprising a pump and a nozzle;
b. determining a liquid selection from a plurality of liquids;
c. determining a shade selection of the beverage;
d. determining a type of beverage to be shaded and a cup size containing said beverage; and
e. activating the pump, thereby delivering the selected liquid to the nozzle in an amount effective to achieve the selected shade, wherein the method is performed by a computing device.

10. One or more non-transitory computer-readable media storing instructions which, when executed by one or more processors, cause performance of a method comprising:
a. determining a liquid selection from a plurality of liquids;
b. determining a shade selection of a beverage;
c. determining a type of beverage to be shaded and a cup size containing said beverage; and
d. activating a pump, thereby delivering the selected liquid to a nozzle in an amount effective to achieve the selected shade.
